(19) United States
(12) Patent Application Publication
(10) Pub. No.: US 2016/0261670 A1
(43) Pub. Date: Sep. 8, 2016

(54) TACTICAL RADIO ADAPTOR

(71) Applicant: Cornet Technology, Inc., Springfield, VA (US)

(72) Inventors: Owen Lyon, North Potomac, MD (US); Ramgopal Divakar, Fairfax, VA (US); Michael S. Hardesty, Woodbridge, VA (US)

(73) Assignee: Cornet Technology, Inc., Springfield, VA (US)

(21) Appl. No.: 14/132,690

(22) Filed: Dec. 18, 2013

Related U.S. Application Data
(60) Provisional application No. 61/838,634, filed on Jun. 24, 2013.

(51) Int. Cl. H04L 29/08; H04W 12/02; G06F 17/27; H04W 4/12

(52) U.S. Cl. CPC H04L 67/025; H04W 4/12; H04W 12/02; G06F 17/2705

(57) ABSTRACT

Systems and methods for tactical radio adapters are described. Systems and methods may provide for remotely changing a transmission method of a tactical radio. System components may include one or more processors; one or more memories; an interface with a communication device; an interface with a tactical radio; a discrete control module; and an audio conditioning module. The systems and methods may automatically switch the tactical radio between plain and secure modes of operation without the use of human intervention.

### FIELD OF THE INVENTION

The present invention relates to systems and methods for communication circuits with conference switches, tactical voice terminals (TVT), and tactical radios, and, more specifically, to systems and methods for adapters related thereto.

### BACKGROUND OF THE INVENTION

While there are different types of radios available, a commonly used radio is the tactical radio. Tactical radios are used by, among other systems, U.S. defense systems positioned on aircrafts, ships and ground stations used for multi-terrain communications. Tactical radios are typically embedded with cryptographic equipment to transmit voice in plain (unencrypted) or secure (encrypted) modes. This particular radio class may contain manual switches controlled by an operator to control the transmission to remote devices in plain and cipher. To date, there is no equipment or mechanism to remotely control these radios. Control is only possible by an operator manually operating the radio.

The U.S. armed forces have been using tactical voice terminals (TVT) and communication switches to communicate from operator positions to radios that transmit analog audio over the air for many years. These tactical voice terminals often contain controls and indicators to permit operators of these devices to communicate in a secure environment. In addition, many of the tactical radios used are field devices, i.e., intended to be deployed in the battlefield or in other harsh conditions. Operators manually control the radios and communicate using a handset connected to the radio. Due to low cost and scaled down size, these tactical radios are being installed in fixed site installations (ground, ship and air). A problem encountered with this scheme is that the tactical radios are incompatible with existing infrastructure at those fixed sites. The pervasive use of analog TVT systems prevents the use of modern tactical radios due to interoperability concerns. It may be prohibitively expensive to replace all legacy analog systems for large installations and/or organizations.

Recently, tactical radios were developed with firmware changes that enable mode change by means of software. The mechanism to control the mode change, however, uses a serial port RS232 protocol with ASCII strings. Nearly all traditional TVT circuits in use do not contain this interface.

Needs exist for improved systems and methods for improved adapters.

### SUMMARY OF THE INVENTION

Embodiments of the present invention solve many of the problems and/or overcome many of the drawbacks and disadvantages of the prior art by providing systems and methods for improved adapters.

Embodiments of the present invention may include systems and methods for remotely changing a transmission method of a tactical radio. System components may include one or more processors; one or more memories; an interface with a communication device; an interface with a tactical radio; a discrete control module; and an audio conditioning module. The systems and methods may automatically switch the tactical radio between plain and secure modes of operation without the use of human intervention.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows incompatibility between tactical radios and TVTs.

FIG. 2 shows an exemplary application of a tactical radio adaptor according to one embodiment.

FIG. 3 is a schematic of an exemplary hardware block diagram of an adaptor according to one embodiment.

FIG. 4 is a schematic of an exemplary high level software processing flow according to one embodiment.

FIG. 5 is a schematic of exemplary computing device components according to one embodiment.

FIG. 6 is a flow diagram illustrating exemplary communications from a tactical radio to a TVT according to one embodiment.

FIG. 7 is a flow diagram illustrating exemplary communications from a TVT to a tactical radio according to one embodiment.

### DETAILED DESCRIPTION OF THE PREFERRED EMBODIMENTS

Embodiments of the present invention may be used in a system of communication circuits with conference switches, tactical voice terminals (TVT), and tactical radios. Exemplary products for use with embodiments described herein may use a microcontroller with interfaces, such as serial ports, such as RS232 serial ports, and embedded firmware running on the device to control and provide compatibility between the two end devices. The description herein describes use with tactical radios for illustrative purposes only. It should be noted that other radios or communications devices may be used with various embodiments described herein. In particular, embodiments of the present invention may be used in any instance where remote control of a communication device is desired.

Embodiments of the present invention may provide systems, methods and apparatus to remotely control a mode of transmission of tactical radios that are capable of transmitting voice in plain (unencrypted) or secure (encrypted) modes. Certain embodiments may provide a translation device to remotely control the TVT, convert signals to serial string messages as understood by the radio, and provide acknowledgement in the opposite direction. Recent changes to tactical radios may allow mode changes via software, but the changed tactical radios may not be compatible with existing communication circuits used by organizations, such as the U.S. Navy. In particular, in typical existing systems, a mode state may be represented by a voltage. The mode state signal may be separate from an audio or other communication signal For example, plain mode may be 24V and secure mode may be 0 V. There is, however, no input to the tactical radios that can understand this voltage state and perform the necessary change. On the other hand, the tactical radios may contain software communicating via a serial port by which these states may be communicated. Therefore, tactical radio adapters according to certain embodiments may interface with conventional communications circuits and a radio, and may act as a liaison between them, allowing a mode change to happen without human intervention.

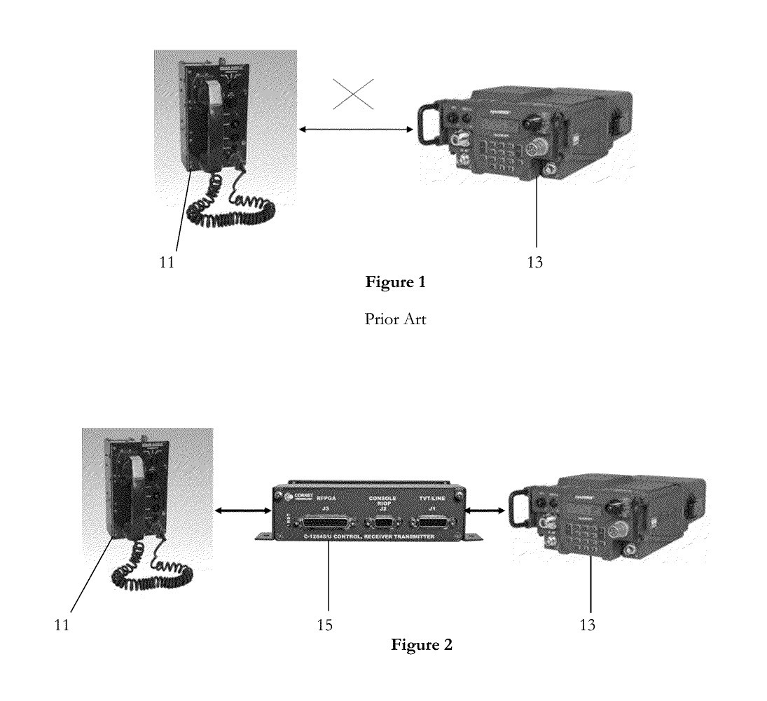

FIG. 1 illustrates a TA-970 phone or tactical voice terminal (TVT) 11 that represents one of many communication devices. A tactical radio 13 may represent one of many radio devices. In a typical existing system, interfaces between a TVT 11 and a radio 13 are not compatible.

In this example, the TVT 11 may communicate a mode request in the form of voltage, such as 24V for plain and 0V for cipher. In return, the TVT 11 may receive an acknowledgement (mode indicate) as a voltage level. The radio 13 may contain a serial port where ASCII messages are required for a mode change. Similarly, an acknowledgement or mode-indicate (acknowledgement) may be provided via the serial port that is message-based rather than by discrete voltage levels. Another signal, often referred to as a “cipher-detect”, may be transmitted by the radio 13 to the TVT 11, which again cannot be processed in the above interface due to incompatibility.

FIG. 2 illustrates an exemplary use of an adapter 15 between a TVT device 11 and a radio 13. The adaptor 15 may interface with tactical radios 13 and TVT devices 11, and may perform the necessary adaptation and translation to permit remote control of the radio 13 by the operator of TVT 11. For example, the mode indicate signal from the TVT device 11 may be converted to an appropriate ASCII message for the tactical radio 13. Similarly, acknowledgements, such as mode-indicate acknowledgements, may be provided via a serial port as an appropriate ASCII message for the tactical radio 13. A cipher-detect may be transmitted by the tactical radio 13 as an ASCII message, but is converted by the adapter 15 to a voltage level.

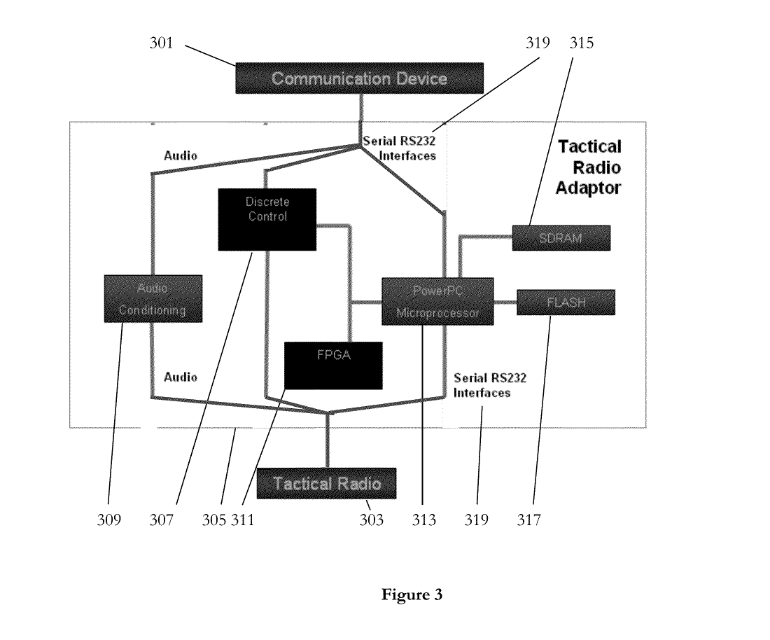

FIG. 3 illustrates an exemplary hardware configuration for an adapter 305 between a communication device 301 and a tactical radio 303. The adapter 305 may include one or more of the following components/modules: discrete control 307, audio conditioning 309, field-programmable gate array (FPGA) 311, one or more processors 313, memory 315, such as SDRAM or similar, memory 317, such as flash memory or similar, and interfaces 319, such as serial RS232 interfaces on one or both ends of the adapter 305.

Discrete Control 307

A discrete may be a non-time varying signal exchanged between radios and tactical voice terminals that defines the state of an operation. For example, radio communication can be encrypted or unencrypted, also worded as cipher or plain. These signals may be unidirectional or bidirectional in nature and may not be as time-varying as analog signals. For example, the user may select cipher from a TVT, which is communicated to the radios through voltages as described herein, finish a conversation that may last several minutes, and then choose to select a plain mode of conversation. These states are not as time-varying as the audio signals and thus may be considered discrete.

A discrete control module 307 may use analog and digital circuits for translating different voltage signals sent by the TVT 301 to a transistor-transistor-logic (TTL) format compatible with the field-programmable gate array (FPGA). For example, a cipher mode could be indicated by 0V and a plain mode by 24V. This may be translated to 0 and 1 for the FPGA at different voltage levels. A “mode select” discrete, discussed herein, may be in the direction from the TVT 301 to the FPGA 311, and a “mode indicate” discrete may be in the direction from FPGA 311 to the TVT 301. Other additional discrete signals may include push-to-talk (PTT) and “cipher detect”. PTT may be required by the radio to transmit audio over the air. Alternatively, when PTT is asserted, then audio is sent via the air; otherwise it is not sent. “Cipher detect” is a message sent by the radio 303 to the adaptor 305 and the TVT 301 informing the adapter 305 and the TVT 301 that the far end user is talking in secure mode. With the help of the radio adaptor 305 all these signals are successfully translated between the TVT 301 and the radios 303.

Audio Conditioning 309

An audio conditioning module 309 may route audio from the communication device 301 and present the audio to the tactical radio 303 and vice versa. One of ordinary skill in the art would understand the necessary basic analog conditioning circuits, such as buffers for strengthening the signals and gain control logic. The TVT discrete may require a transformer controlled logic, while the radio 303 may not. A “cipher detect” discrete may require a transformer, while the radio 303 may not have a balanced interface. The audio conditioning circuit 307 may address these differences and provide a seamless interface between the TVT 301 and the one or more radios 303.

Computing Components

Hardware and/or software may be required to make the various pieces of equipment adapt to one another. One or more processors 313, such as PowerPC microprocessors, with embedded serial interfaces 319, may be used. The one or more microprocessors 319 may use a memory 317, such as a flash memory, to store passwords, encryption algorithms, program code, static data, backup configuration parameters, etc.

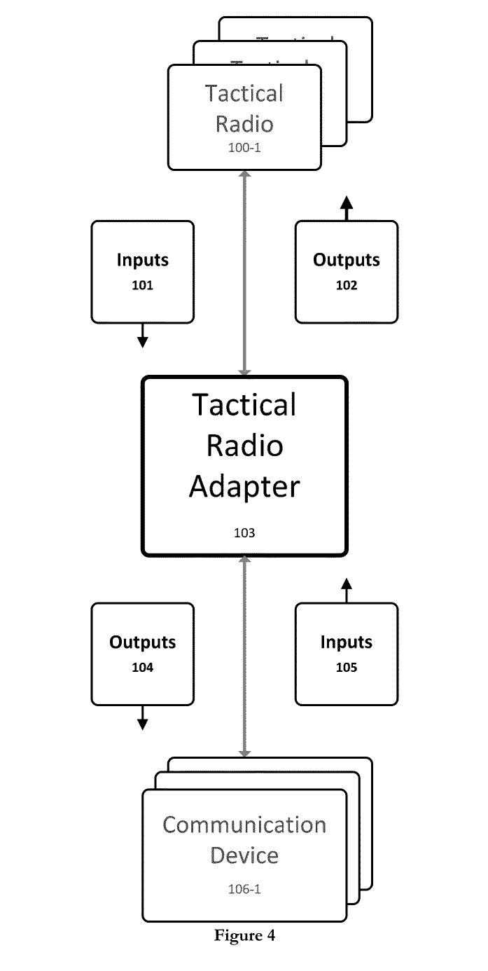

FIG. 4 depicts the high level data flow for an adaptor 103. Typically, an interface with one or more tactical radios 100-x may include three types (inputs 101, outputs 102): serial port(s), bidirectional analog audio, and discretes (voltage levels and definitions vary). The serial ports may transfer ASCII-type or similar messages and may be used to control and monitor activity of the tactical radio 100-x. There may be an addition mode of operation, pass-through, which permits firmware upgrades of the tactical radios 100-x through the adaptor 103. Firmware upgrades may be possible without re-cabling of interfaces. In this mode of operation, the adaptor 103 may become a passive device and may only monitor activity. Similarly, the interface to one or more TVTs 106-x, which may include three types of interfaces (outputs 104, inputs 105) as described above. Each interface, however, may be unique and may include various protocols, level translations and transmission characteristics.

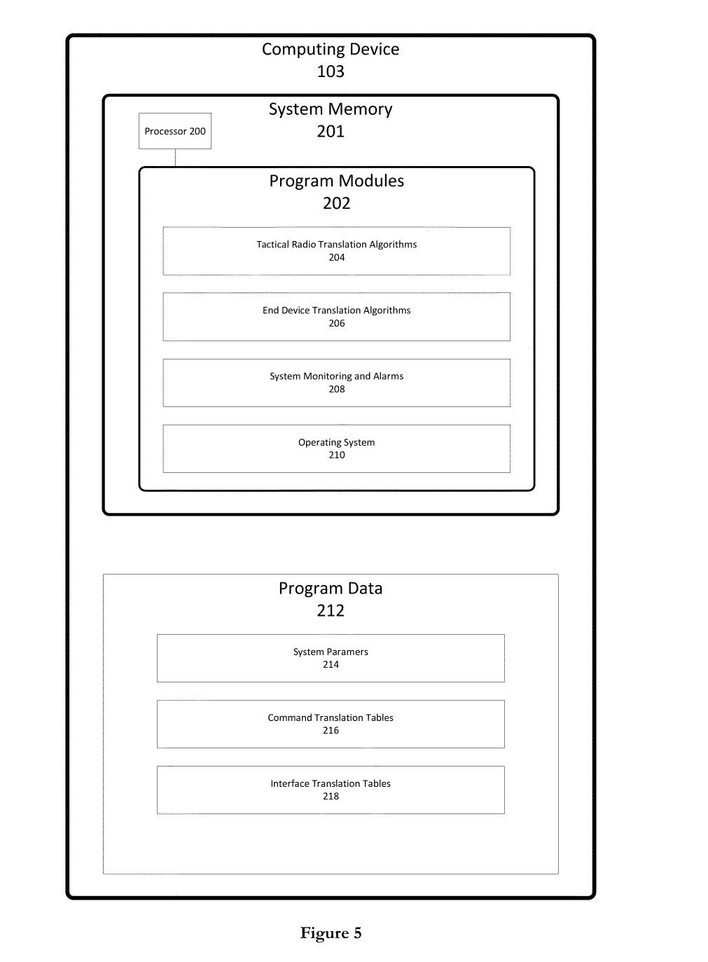

FIG. 5 illustrates an exemplary computing device model 103. Individual program modules may be modular in that they may contain specific translation tables (command translation tables 216, interface translation tables 218) and algorithms (tactical radio translation algorithms 204, end device translation algorithms 206) specific to the tactical radios and TVT devices connected to the adaptor 103.

The command translation tables 216 may include multilevel string parsing and insertion of the serial data stream with the tactical radio. In addition, the translation may vary for each type of tactical radio connected. Interpretation of the strings may also vary depending on the mode of the radio. Message filtering may be performed to filter out messages of no interest. Data integrity checks may be performed to validate data fields to protect against corrupted data transfers. Tables may be maintained that contain a list of the known commands supported by the tactical radios. The tables may be multi-level in that many commands may require further parsing as they have multiple variations. Command response tables may also be maintained that contain string entries of expected responses.

System monitoring and alarm modules 208 may contain both common and device specific sub-modules. Operating systems 210 utilized may include but are not limited to Linux and Nucleus. Program data 212 may also include system parameters 214.

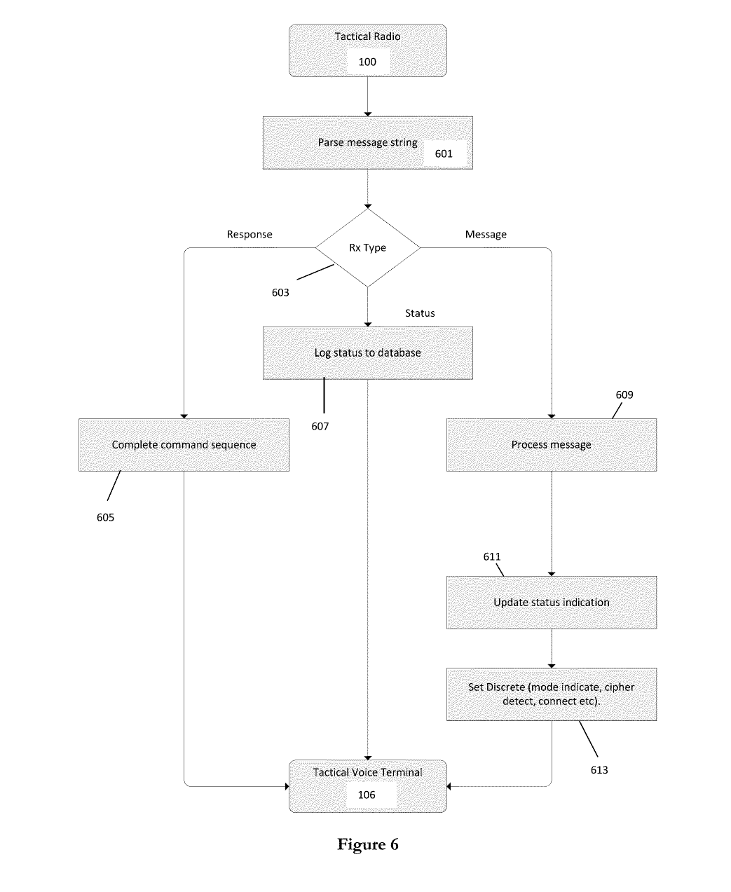

FIG. 6 depicts a typical flow of message processing from a tactical radio 100 translated into discrete signal changes on a TVT 106 interface. A message string from a tactical radio 100 may be preprocessed 601. The preprocessing 601 may determine if the message received from the radio is an asynchronous status update, command echo, or response to a command that has been issued. This may be implemented using string parsing and/or pre-canned lookup translation tables. Once the message is categorized the process may be directed at unique algorithms specific to the message type. Command echoes may typically be used as an integrity check and internal statistics may be maintained.

A message type may be determined 603. Messages may include mode change acknowledgement, command acknowledgements, alarms, etc. In addition to signal changes, LED indicators may also be updated to provide a visual status of tactical radio events. If the message type is determined to be a response, a command sequence may be completed 605 before being sent to a TVT 106. Command responses may be received as a result of commands issued or notifications of changes in manual front panel controls such as radio mode (e.g., normal vs. program mode). Since mode changes made to the tactical radios may only be performed when the radios are in program mode, special routines may be added to ensure that the radios are returned to a normal mode of operation. This may be a safeguard against unintended anomalies that may occur during the message sequencing. These may be timed sequences in cases where the intended operation did not successfully complete within the maximum allotted time the radio is forced back to normal mode so communication may commence.

If the message type is determined to be a status, the status may be logged to a database 607, before passing to the TVT 106. If the message type is determined to be a message, the message may be processed 609. Asynchronous messages may be analyzed to determine if they are messages of interest. An example may be detection of a mode indicate (plain or cipher). This may represent a mode change detected from the far-end device, for example, a radio on an aircraft controlled by a pilot. Since many messages have multiple variations further parsing and table lookup sequences may be required. In addition, type and bound checks may be performed to detect anomalies used to guard against catastrophic states. States changes detected may result in actions performed on the communication device.

A status indication may be updated 611, and a discrete may be set 613 (mode indicate, cipher detect, connect, etc.). Depending on the specific communication device this can be discrete analog signals, digital signals and/or serial communication unique to the end device. Incorporated in the implementation may be specialized hardware interfaces configured to be under software control through the use of field programmable gate arrays (FPGAs). Memory mapped registers implemented in the FPGAs may permit read/write operations with the various discrete signals (analog and digital).

The message may then be sent to the TVT 106.

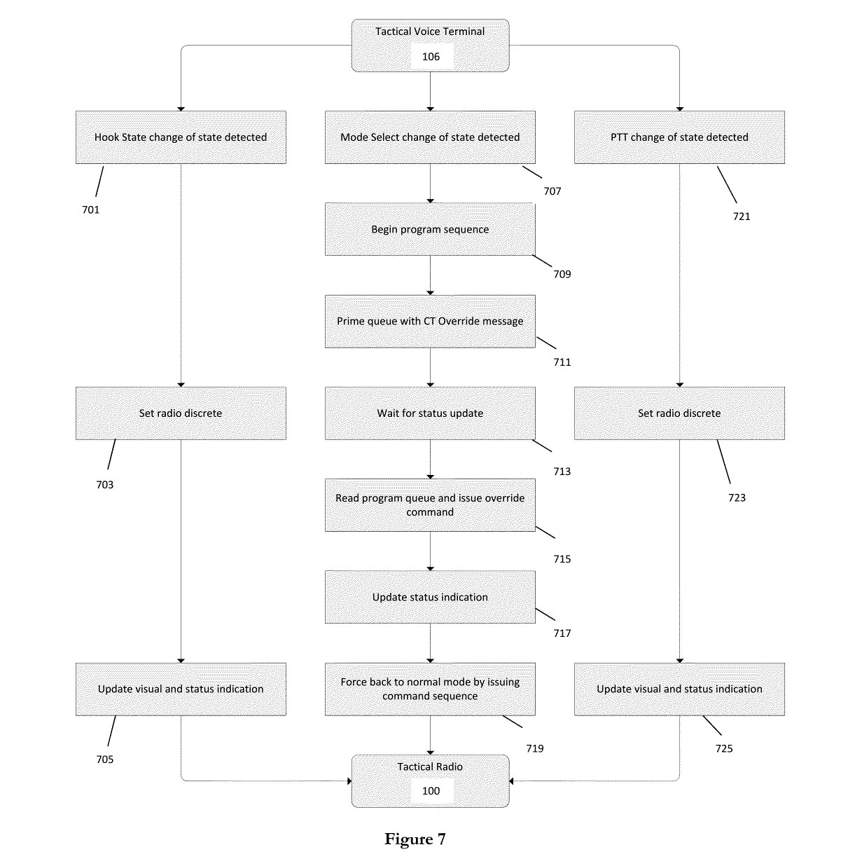

Specialized hardware interfaces presented to the software via memory mapped FPGA registers may contain representations of each discrete signal to/from the TVT. Each signal may be mapped to interrupt vectors that branch to individual processing routines. Software debounce may be incorporated to filter out signal chatter. Mode changes may require the most processing since the tactical radios need to be forced to program mode. This may be implemented using a state machine that serves two main functions—normal processing mode and safeguard processing to non-intrusively return the tactical radios to a normal operating mode when anomalies are detected. FIG. 7 depicts the normal processing sequence in the absence of anomalies. Commands may be issued to the tactical radios to represent the equivalent operation represented by the discrete signal changes.

FIG. 7 depicts the flow from the TVT 106 to the tactical radio 100. Changes in discrete signals may be detected and translated into both serial message commands and optionally discrete communications to the radio 100. Safeguards may be added to prevent communication loss with the tactical radio and verifications that mode changes between plain and encrypted voice have actually been applied. In one path, a change of state may be detected 701. A discrete communication from the radio may be set 703. Visual and status indications may be set 705, and the message may be sent to the tactical radio 100. In another path, a mode select change of state may be detected 707. A program sequence may begin 709, followed by a prime queue with cipher type override message 711. The system may then wait for a status update 713. A program queue may be read and an override command may be issued 715. Status indication(s) may be updated 717. The system may be forced back to normal mode by issuing a command sequence 719, and signals may be sent to a tactical radio. In another path, a PTT change of status may be detected 721. Radio discrete(s) may be set 723. Visual and status indications may be updated 725, and the message may be sent to the tactical radio 100.

Since firmware for the tactical radios is likely to change once in the field, provisions may be included in the adaptor to accommodate firmware upgrades. This may be required when modifications are made to the software protocol or new features have been requested by the customer. Schemes may utilize one or more of the serial ports to upload new firmware to an adaptor.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

1. A system for remotely changing a transmission method of a tactical radio, the system comprising:
one or more processors;
one or more memories;
an interface with a communication device;
an interface with a tactical radio;
a discrete control module; and
an audio conditioning module,
wherein the system automatically switches the tactical radio between plain and secure modes of operation without the use of human intervention.

2. The system of claim 1, wherein the communication device is a tactical voice terminal.

3. The system of claim 1, wherein the interface with the communication device is a serial port.

4. The system of claim 1, wherein the interface with the tactical radio is a serial port.

5. The system of claim 1, wherein the discrete control module converts discrete signals from the communication device to the tactical radio.

6. The system of claim 1, wherein the audio conditioning module routes audio between the communication device and the tactical radio.

7. The system of claim 1, wherein the system has a pass through mode to allow firmware upgrades of the tactical radio.

8. A method for remotely changing a transmission method of a tactical radio, the method comprising:
receiving, at a device, a message from a communication device;
determining, by the device, if a change of state is necessary;
setting, by the device, a radio discrete;
remotely controlling, by the device, the mode of operation of the tactical radio based on the determined need of state change; and
transmitting the message to the tactical radio in the determined mode of operation, wherein the determined mode is selected by the device from plain and secure modes of operation.

9. The method of claim 8, wherein the communication device is a tactical voice terminal.

10. The method of claim 8, further comprising remotely controlling transmit gating of an audio push to talk communication.

11. The method of claim 8, further comprising detecting both mode indication and cipher detect.

12. The method of claim 8, further comprising converting discrete signals and serial interface protocols from various communications devices to various tactical radios.

13. The method of claim 8, further comprising switching to a pass-through mode that permits firmware upgrades of the tactical radio.

14. The method of claim 8, further comprising permitting firmware upgrades of the tactical radio in the field if protocols or features change.

15. The method of claim 8, further comprising updating visual and status indications.

16. A method for remotely changing a transmission method of a tactical radio, the method comprising:
receiving, at a device, a message from one or more tactical radios at a radio interface;
parsing, by the device, the message;
determining, by the device, a message type of the message;
processing, by the device, the message based on the message type;
updating, by the device, status indications based on the message type;
setting, by the device, discrete controls based on the message type; and
transmitting, by the device, the message in the proper mode of operation to a communication device based on the set discrete controls, wherein the proper mode is selected by the device from plain and secure modes of operation.

17. The method of claim 16, further comprising transmitting firmware upgrades to the tactical radio.

18. The method of claim 16, further comprising logging a status into one or more databases.

19. The method of claim 16, further comprising completing a command sequence.

20. The method of claim 16, wherein the communication device is a tactical voice terminal.
